(19) United States
(12) Patent Application Publication
(10) Pub. No.: US 2025/0293525 A1
(43) Pub. Date: Sep. 18, 2025

(54) DISTRIBUTED ENERGY RESOURCE MANAGEMENT

(71) Applicant: GM Global Technology Operations LLC, Detroit, MI (US)

(72) Inventors: Venkata Naga Siva Vikas Vemuri, Farmington Hills, MI (US); Chandra S. Namuduri, Troy, MI (US); Andrew J. MacDonald, Grosse Pointe Park, MI (US); John Sergakis, Bloomfield Hills, MI (US)

(21) Appl. No.: 18/604,958

(22) Filed: Mar. 14, 2024

(51) Int. Cl. H02J 3/46; H02J 3/38; H02J 13/00

(52) U.S. Cl. CPC H02J 3/466; H02J 3/381; H02J 13/00002; H02J 13/00026; H02J 2310/40

(57) ABSTRACT

a process for responding to an energy demand event includes identifying an energy demand event and ranking multiple distributed energy resources according to a dynamic state of health of each distributed energy resource. At least one of the distributed energy resources is assigned to meet the demand event. An anomaly count of at least one of the at least one distributed energy resources is monitored throughout the energy demand event.

### INTRODUCTION

The subject disclosure relates to control and scheduling of distributed energy resources, and more particularly to a system for optimally providing energy from multiple distributed energy resources to one or more energy systems in response to an energy demand event.

Distributed energy systems utilize power plants (sources), such as conventional non-renewable power production plants, modern renewable production facilities, or any combination thereof to generate energy. The energy is distributed through an energy distribution system to one or more end systems. In some cases, such as solar production, energy generation from a given facility can vary in magnitude. In such cases, the excess energy in one period can be stored in multiple energy resources, such as battery systems, storage banks, electric vehicles, etc., The various resources where the energy is stored are distributed geographically with some resources being mobile and other resources being immobile.

When the generated energy is insufficient to meet a demand, or energy is not being generated due to either planned or unplanned events, an energy demand event occurs. The energy demand event requires withdrawing energy from one or more of the resources in which the energy is stored in order to provide energy to another location or to a general energy grid. In some systems multiple energy demand events can occur simultaneously.

Due to the distributed nature of the energy resources, the stored energy is geographically distributed and may not be readily available at a particular location (e.g. energy may be stored at one location while the demand event is occurring 25 miles away.) Additionally, some resources may be more suited to providing stored energy to some energy systems and less suited to providing stored energy to other energy systems during a demand event.

As such, it is desirable adaptively schedule and deliver power from multiple distributed energy resources where the system accounts for the energy capabilities and requirements of the energy demand event and the energy resources.

### SUMMARY

In one exemplary embodiment a process for responding to an energy demand event includes identifying an energy demand event, ranking a plurality of distributed energy resources according to a dynamic state of health of each distributed energy resource, assigning at least one distributed energy resource to meet the demand event, and monitoring an anomaly count of at least one of the at least one distributed energy resources throughout the energy demand event.

In addition to one or more of the features described herein ranking the plurality of distributed energy resources includes receiving a set of key performance indicator metrics from each resource, determining a key performance indicator value corresponding to each key performance indicator metric using a key performance indicator determinator, and determining a dynamic state of health indicator value corresponding to the key performance indicator value for each key performance indicator metric using a dynamic state of health determinator.

In addition to one or more of the features described herein at least one of the key performance indicator determinator and the dynamic state of health determinator is a software module local to the corresponding distributed energy resource.

In addition to one or more of the features described herein at least one of the key performance indicator determinator and the dynamic state of health determinator is a software module local to the corresponding distributed energy resource is remote from the corresponding distributed energy resource.

In addition to one or more of the features described herein at least one of the key performance indicator determinator and the dynamic state of health determinator is a rules based determinator.

In addition to one or more of the features described herein at least one of the key performance indicator determinator and the dynamic state of health determinator is at least partially machine learning based, and wherein a machine learning of the at least one of the key performance indicator determinator and the dynamic state of health determinator is retrained using outputs of the at least one of the key performance indicator determinator and the dynamic state of health determinator.

In addition to one or more of the features described herein each of the key performance indicator determinator and the dynamic state of health determinator are at least partially machine learning based.

In addition to one or more of the features described herein, the process further includes determining a total dynamic state of health value based on an average of each key performance indicator dynamic state of health value.

In addition to one or more of the features described herein the average is a weighted average.

In addition to one or more of the features described herein at least one of the dynamic state of health indicator values is based at least in part on a historical average of the key performance indicator values of the corresponding key performance indicator metric.

In addition to one or more of the features described herein assigning the at least one distributed energy resource to meet the demand event comprises applying a throughput versus latency optimization algorithm, wherein a throughput of a resource is a magnitude of energy provided by the resource and a latency of the resource is a time until completed delivery of the energy provided by the resource.

In addition to one or more of the features described herein applying the throughput versus latency optimization comprises evaluating a throughput and latency of each resource in the plurality of distributed energy resources and assigning the at least one distributed energy resource to meet the demand event comprises assigning an optimal subset of the plurality of distributed energy resources to meet the demand event.

In addition to one or more of the features described herein assigning the optimal subset of the plurality of distributed energy resources comprises instructing at least one mobile distributed energy resource to move from a first location to a second location.

In addition to one or more of the features described herein monitoring an anomaly count of at least one of the at least one distributed energy resources throughout the energy demand event comprises monitoring each key performance indicator, incrementing an anomaly counter in response to detecting an anomaly, comparing the anomaly counter to a threshold and disengaging the distributed energy resource from the energy demand event in response to the anomaly counter exceeding the threshold.

In addition to one or more of the features described herein, the process may further include responding to an end of the energy demand event by interrupting the monitoring the anomaly count of at least one of the at least one distributed energy resources and disengaging the distributed energy resource from the energy demand event.

In addition to one or more of the features described herein the plurality of distributed energy resources includes a set of mobile distributed energy resources and a set of immobile distributed energy resources.

In addition to one or more of the features described herein the set of mobile distributed energy resources includes at least one vehicle, and wherein the at least one vehicle includes a rechargeable energy storage system and a controller.

In addition to one or more of the features described herein the method includes determining a key performance indicator value corresponding to each key performance indicator metric using a key performance indicator determinator and determining a dynamic state of health indicator value corresponding to the key performance indicator value for each key performance indicator metric using a dynamic state of health determinator, and wherein at least one of the key performance indicator determinator and the dynamic state of health determinator is a software module of the controller.

In addition to one or more of the features described herein each mobile distributed energy resource in the set of mobile distributed energy resources includes a controller, and wherein each controller includes a corresponding key performance indicator determinator and a corresponding dynamic state of health determinator.

In addition to one or more of the features described herein, the process further includes identifying at least one additional energy demand event, reiterating the ranking the plurality of distributed energy resources according to a dynamic state of health of each distributed energy resource, and assigning at least one distributed energy resource to meet the at least one additional energy demand event. Assigning at least one distributed energy resource to meet the at least one additional energy demand event includes identifying a distributed energy resource currently assigned to an energy demand event and reassigning the identified distributed energy resource to one of the at least one additional energy demand events.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a view of a distributed energy resource scheduling system including a top down view of a motor vehicle and multiple additional distributed energy resources;

FIG. 2 depicts illustrates a high level process flow of a resource scheduler for an energy demand event;

FIG. 3 depicts a scheduling process operated by a scheduler when an energy demand event occurs;

FIG. 4 depicts one example planning algorithm using a throughput versus latency optimization; and

FIG. 5 depicts a process for monitoring a resource that has been engaged to meet an energy demand event throughout the energy demand event.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment methods, devices and systems are provided for scheduling and implementing delivery of energy from distributed energy resources to at least one receiving energy system. To implement the scheduling, a scheduler identifies state of health metrics, abstract resource metrics and external factor metrics for each distributed energy resource. A key performance indicator (KPI) for each metric is determined, and the KPIs are combined into an dynamic state of health indicator using a dynamic state of health determinator.

The dynamic state of health indicator of each distributed resource is provided to a distributed energy resource scheduler. The dynamic state of health indicator can be provided as a single percentile value aggregating all performance indicators of the resource, a table including the performance indicators and the aggregated percentile value. The distributed energy resource scheduler identifies areas within an overall energy distribution system with an energy need and assigns distributed energy resources to fill that need. In some examples, the assignment can include directing one or more of the distributed energy resources to move from a current location to a new location. In another example, the assignment can include identifying a future location of a distributed energy resource and instructing a receiving energy system to stand by for connection of the distributed energy resource at a future time.

In any example, the distributed energy resource scheduler balances a throughput (magnitude of energy provided) and a latency (time until delivery of provided energy) of each distributed energy resource based on the key performance indicators of all of the distributed energy resources and optimizes delivery of the energy from the distributed energy resources to energy systems in need of the resources. It is appreciated that an “optimal” solution is dependent on numerous tangible and intangible factors. As used herein, optimal, optimum, optimizing, and any related terms refer to identifying and/or utilizing a system having improved characteristics relative to any identified tangible and intangible factors and should not be construed as an absolute optimum for every circumstance.

Embodiments described herein present numerous advantages and technical effects. Implementation of the scheduling system provides a situational awareness algorithm that efficiently utilizes multiple available distributed energy resources to optimally meet energy demands. The optimization provides cost and load benefits to energy savings and distribution. In addition, the optimization can preserve battery health of the available resources by prioritizing healthier resources and monitoring the use and deployment of resources across a network of distributed energy resources.

The embodiments are not limited to use with any specific vehicles and may be applicable to various contexts. For example, the distributed energy resources may include vehicles, buildings, battery storage systems, and any number of other mobile or immobile energy storage facilities.

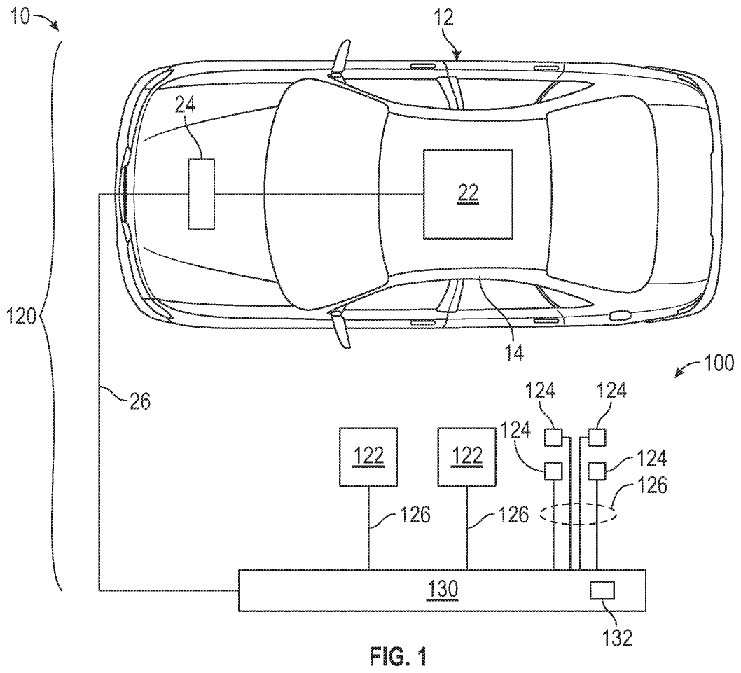

FIG. 1 shows an embodiment of a motor vehicle 10, which includes a vehicle body 12 defining, at least in part, an occupant compartment 14. The vehicle body 12 also supports various vehicle subsystems including a propulsion system, and other subsystems to support functions of the propulsion system and other vehicle components, such as a braking subsystem, a suspension system, a steering subsystem, a fuel injection subsystem, an exhaust subsystem and others.

The vehicle 10 may be an electrically powered vehicle (EV) or a hybrid vehicle. In an embodiment, the vehicle 10 is an electric vehicle including at least one electric motor assembly.

The vehicle 10 includes a battery system 22, which may be electrically connected to electrically powered subsystems, such as vehicle electronics, motors, sensors, and the like. The battery system 22 may be configured as a rechargeable energy storage system (RESS). In such examples, the vehicle 10 further includes a controller 24 configured to control the battery system 22. The controller 24 can be a single dedicated controller, a general vehicle controller or multiple controllers distributed throughout the vehicle 10 and operating in coordination with each other to control one or more features of the battery system 22.

In addition, the controller 24 is communicatively coupled to a remote computer system 130 via a communication link 26. The communication link 26 can be a wireless (e.g. cellular) communication, a network based communication including wired and wireless sub connections, and/or a direct wired connection.

The vehicle 10 is one distributed energy resource (resource 120) of a distributed energy resource system 100. The distributed energy resource system 100 includes multiple distributed energy resources 10, 122, 124 including stationary energy resources 122 such as buildings, energy storage sites, and the like and multiple mobile energy resources 124 such as electric vehicles similar to, or the same as, the vehicle 10, different electric vehicles and any other mobile energy storage components. The vehicle 10 can be considered one instance of the mobile resources 124.

The remote computer system 130 is in communication with each resource 120 via two-way communication links 26, 126. Included within the remote computer system is a distributed energy resource scheduler (referred to as the scheduler 132) configured to receive information from each of the resources 120 and respond to an impending energy demand by allocating one or more resource 120 to provide energy to meet the demand.

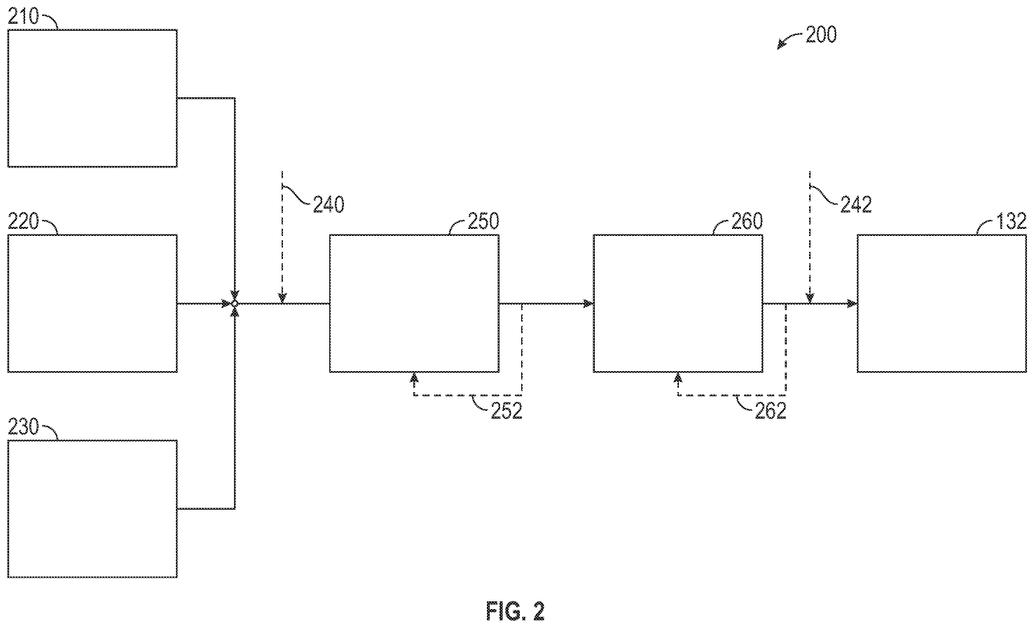

With continued reference to FIG. 1, FIG. 2 illustrates a high level process flow 200 of the scheduler 132. Each resource 120 generates resource state of health (SOH) metrics 210, abstract resource metrics 220, and any available external factor metrics 230. These are referred to generically as metrics 210, 220, 230.

The state of health metrics 210 can include factors such as a rate of discharge, an average rate of output power, a maximum rate of output power, an average rate of output voltage, an average DC to AC (direct current to alternating current) feedback, a number of discharge channels, a percentage below threshold, an average rate of charge degradation, and average current fluctuation, or any similar metrics indicative of a state of health of the corresponding resource 120. As used herein, the percentage below threshold refers to an industry standard defined threshold for DC-AC conversion, and may vary according to conventional practices depending on the specific implementation.

The abstract resource metrics 220 can include a probability of sufficient charge level, an age of the energy storage systems (e.g., batteries) within the resource 120, a number of previous engagements of the resource 120, a time since a last service of the resource 120, a fleet charge type, a level of autonomy of the resource 120, a number of charge cycles of the resource 120, and any similar metrics.

The available external factor metrics can include time of day, GPS location of the resource 120, weather at the location of the resource 120, any special conditions applicable to the resource 120 (e.g., within a construction zone, limited range, immobile, et.), or any similar factors that are not directly tied to the resource 120 itself, but will impact the ability of the resource 120 to provide energy.

Each of the factors 210, 220, 230 is synthesized into a key performance indicator using a key performance indicator determinator 250. In some cases the factors 210, 220, 230 are provided to the remote computing system 130 at a remote server start 240, and the key performance indicator determinator 250 is located at the remote computing system 130, as well as all subsequent elements of the process flow 200. In other cases, some or all of the resources 120 include a key performance indicator determinator 250 within their own controller and the key performance indicators are determined before providing the factors to the remote computing system 130.

In some examples, the key performance indicator determinator 250 uses a predefined rule for each metric 210, 220, 230 to determine a corresponding pass/fail indication (1=pass, 0=fail), and assigns that factor 210, 220, 230 the corresponding numerical value. In alternate examples, the pass/fail value of the key performance indicator determinator 250 utilizes an AI/machine learning algorithm to determine the key performance indication for each factor 210, 220, 230 and the outputs can be fed back using an option feedback loop 252 to retrain/update the AI/machine learning model.

In another example, one or more of the key performance indicator metrics 210 can be a percentile value (0%-100%), or a similar non-binary value within a preset range, instead of using the pass/fail evaluation.

In yet further examples the key performance indicator metric 210 can be reported as a percentile or non-binary value within a preset range, and is converted to a binary pass/fail value based on a predetermined condition (e.g. percentile greater than X, non-binary value less than Y, etc.)

The key performance indicator metrics 210, 220, 230 are then provided to a dynamic state of health determinator 260. The dynamic state of health determinator 260 determines a dynamic state of health of each metric 210, 220, 230, and combines the dynamic state of health metrics into a total dynamic state of health of the resource 120. The dynamic state of health determinator 260 can be either rules based, or utilize the illustrated AI/ML feedback loop 262.

In one exemplary implementation, the dynamic state of health indicator is the pass/fail value, and the total dynamic health value is a percentile of the passing dynamic health values. By way of example, in a resource 120 with ten KPI's seven of which are passing (assigned a value of “1”), the dynamic total health value is 70%.

In alternate example implementations, certain factors 210, 220, 230 may have a weighting constant multiplied with the value, thereby increasing or decreasing the impact of that metric on the total dynamic health.

In yet other examples, the dynamic state of health of a given resource 120 can be determined based on historically received KPI values (e.g., a threshold percent of X previous values being passing) and/or based on additional external factors or conditions, where the instantaneous pass/fail of a given KPI metric 210, 220, 230 is not, by itself, determinative of the corresponding dynamic state of health.

After the dynamic state of health determinator 260 identifies the state of health indicator for the resource 120, the key performance indicators and dynamic state of health indicators are consolidated into a table that is provided to a scheduler 132 in the remote computing system 130 and the table is used by the scheduler 132 to determine an overall suitability of the corresponding resource 120 based on the corresponding total scores. In some examples, everything prior to the scheduler 132 can be handled by the resource 120 being analyzed and the remote server start point 242 is utilized.

By way of example, the table for a backup battery storage may be as follows:

| Backup Battery | | Dynamic |
|---|---|---|
| Metrics | KPI | SoH Score |
| Capacity | 0 or 1 | 1 |
| SOC | % | 1 |
| SOH | % | 1 |
| Redundancy | 0 or 1 | 1 |
| Check | | |
| Backup | 0 or 1 | 1 |
| Availability | | |
| Total | Total metric score/ | 5/5 = 100% |
| Confidence | Total no. of | |
| Score | metrics = 1 or 0 | |

With the first column indicating the factor, the second column providing a pass/fail value for that factor, and the third column providing the dynamic state of health (SoH). The particular threshold values of the second column are application dependent, and will be specific to a given battery backup resource 120.

Similarly, when the resource 120 is a fuel cell based resource, the key performance indicators may be as follows:

| Fuel Cell Metrics | KPI | Dynamic SoH Score |
|---|---|---|
| Hydrogen storage capacity | 1 | 1 |
| Hydrogen rate of availability | 1 | 0 |
| Ambient temperature | 0 | 1 |
| Load factor | 0 | 1 |
| Operational efficiency | 0 | 1 |
| Voltage Converter efficiency- | 1 | 1 |
| Boost ratio (=Threshold) | | |
| Air Quality | 1 | 1 |
| Humidity | 0 | 1 |
| Total Confidence Score | Total metric | 7/8 = 87.5% |
| | score/Total no. of | |
| | metrics = 1 or 0 | |

With the first column indicating the factor, the second column indicating the key performance indicator pass/fail value, and the third column indicating the resource rating from the dynamic state of health determinator 260. In this example, the dynamic state of health scores are based on an average historical pass/fail rate including the current pass/fail value of the KPI metric, and are not exclusively determined by the corresponding current pass/fail value.

In another example, the resource 120 may be a wind energy based resource, and the scheduler 132 information table may be as follows:

| WIND ENERGY | | Dynamic |
|---|---|---|
| METRICS | KPI | SoH Score |
| Capacity Utilization rate (% | 75% | 1 |
| Of max possible outputs) | | |
| Levelized Cost of energy | 0 | 0 |
| (Avg total cost = Threshold | | |
| then 1 or it is 0) | | |
| Energy Payback Time (Time | 1 | 1 |
| taken for renewable energy | | |
| source) | | |
| Operational efficiency (If | 1 | 1 |
| efficiency greater than or | | |
| equal to threshold, then 1 or | | |
| else 0) | | |
| Load factor (If load factor | 1 | 1 |
| greater than or equal to | | |
| threshold, then 1 or else 0) | | |
| Energy Storage Capacity | 1 | 1 |
| (Ability to store capacity for | | |
| later Use) | | |
| Carbon Reduction Value | 1 | 1 |
| External factors (Sun, Wind, | 80% | 1 (avg th % |
| Avg time and intensity of | | is greater) |
| such prime sources- %) | | |
| Total | | 7/8 = 87.5% |

With the first column indicating the factor, the second column indicating the pass/fail condition of the factor, and the third column indicating the resource rating from the dynamic state of health determinator 260.

With continued reference to FIGS. 1-2, FIG. 3 illustrates a scheduling process 300 operated by the scheduler 132 when an energy demand event occurs. By way of example, an energy demand event occurs when a resource 120 indicates that an amount of energy will be required and that currently available resources 120 (e.g., a power grid) are unavailable. An energy demand event can occur when a power grid is off due to weather events, when locally stored energy resources are insufficient, when energy costs from a grid are higher than a desired level, or any similar event.

When an energy demand event occurs, the remote computing system 130 initiates the scheduling process 300 at a start block 310. Initially, the scheduling process 300 dynamically maps the locations of available distributed energy resources 120, including vehicles, buildings, battery storage sites, etc. in a mapping step 320 by communicating with each resource 120 and determining a current location of that resource 120. In some examples, resources 120 that are known to be immobile (e.g. a building based energy storage system) can be predetermined and the location is not required for the mapping step 320.

In some examples, the mapping step 320 can be limited to resources 120 known or expected to be within a certain range of the demand event. In other examples, the mapping step 320 may extend to a full network of resources 120.

Once all resources 120 have been mapped, the process 300 priorities (ranks) the available resources 120 based on the total dynamic state of health values in key performance indicators step 330. In one example, the ranking is performed from low (lowest value total dynamic state of health indicator) to high (highest value dynamic state of health indicator), with the values being the total dynamic state of health values from the provided tables and being based on a set number of the most recent engagements. As used herein, a particular resource engagement refers to an occurrence of that particular resource 120 being used to respond to a demand event.

Once the available resources 120 are ranked, the process 300 uses an engagement demand function within a dynamic area of the demand event for a given period of time at a determine demand step 340. The engagement function determines the estimated capacity of each resource 120 within a range of the demand event and the approximate energy demand required by the demand event. The approximate energy demand of the demand event includes an estimated amount of energy required and an estimated time for which the energy will be required. In instances where an algorithm is used to optimize energy delivery, the estimated demand includes an estimated latency requirement (e.g. the demand must be met within a specified time period).

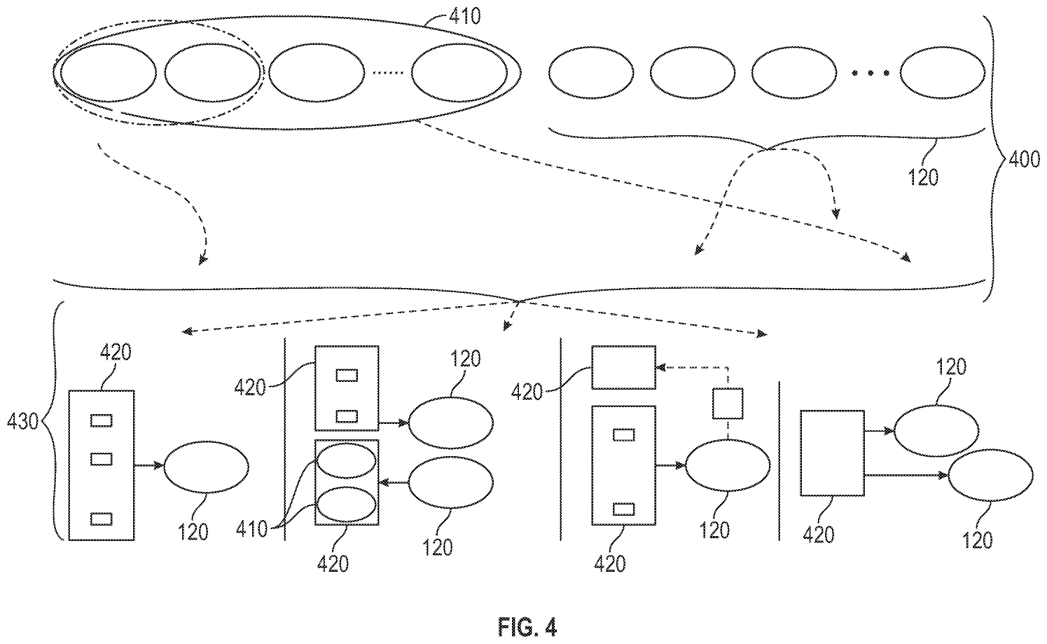

The demand is compared to the estimated capacity of all available resources 120 in a comparison check 350. When the demand is less than the capacity, the process 300 assigns the higher rank resources 120 to meet the demand event 410 (FIG. 4) and moves the lower scored resources 120 to a reserve buffer in a provide power step 370. In some cases, such as cases where the resources 120 include mobile resources 124, the system 300 is configured to instruct automated systems within the mobile resources 124 to move the resource 120 to a location for delivery of stored energy to meet the demand event 410. This can include disengaging a resource 120 from one source 420, moving the resource 120, and engaging the resource 120 with the source 420 experiencing the demand event 410 Similarly, when the mobile resources 124 do not include automated driving, the system 300 can anticipate typical movement of the mobile resource 124 (e.g., a vehicle is expected to be moved from a home location to a work location on a business day), and the natural movement of the mobile resource 124 is accounted for.

When the demand exceeds the estimated capacity, the process 300 creates a plan to increase the available capacity in the next time period (e.g., hours, days etc.) at step 360. The plan can involve moving mobile resources 124, storing excess energy at one or more stationary resources 122 and shifting the energy to the source 420 experiencing the demand event 410, or any similar action.

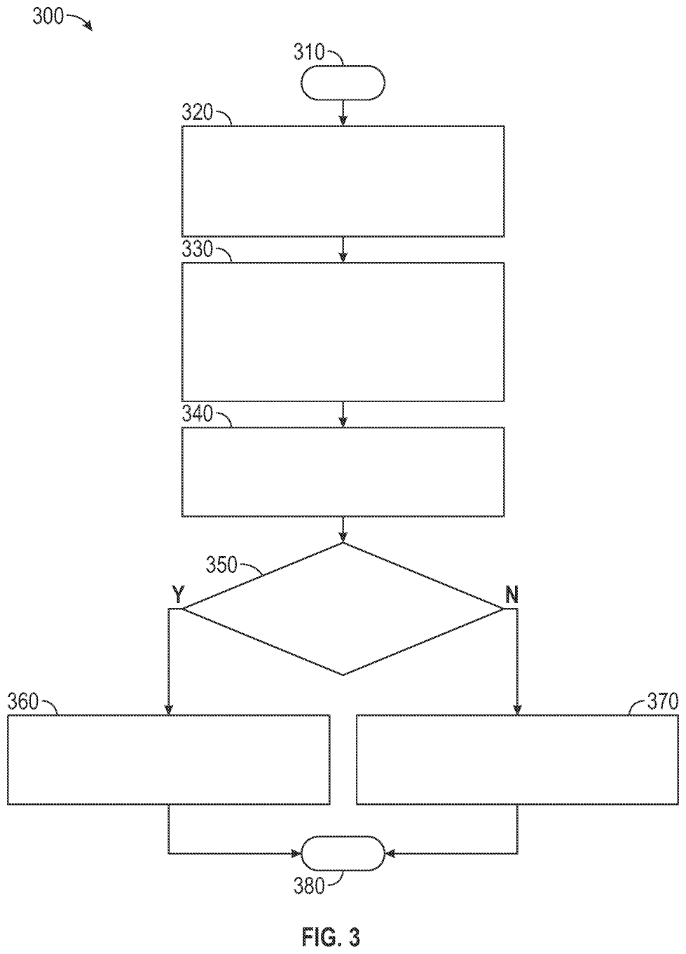

With continued reference to FIG. 3, FIG. 4 illustrates an example planning algorithm 400 using a throughput versus latency optimization which optimizes delivery of energy to meet an energy demand event 410. The throughput of a given resource 120 is the amount of energy that can be delivered from the resource 120, while the latency of a resource 120 is the time it takes to deliver that energy to a given demand event 410. In some cases, such as an immobile resource 120 that is already connected at the demand event 410 (e.g., a battery backup system), the latency will be limited to the time required to discharge the energy. In other cases, such as an electrical vehicle 10 being moved to provide power at an alternate location, the latency will include the time to move the resource 120 into position such that the resource can provide the energy and the time required to discharge the energy.

The example plan algorithm 400 of FIG. 4. provides an optimal plan for responding to multiple different demand events 410, as well as continuing to provide resources 120 for storing energy generated at different sources 420 in an overall energy distribution network 430 according to the previously determined ranking of resources 120. As the plan algorithm 400 utilizes constraints requiring the throughput to meet a predefined amount and the latency to be below a predefined amount, the methodology is referred to as constraint solving for the optimization problem.

After either a plan for meeting the demand (step 360) has been constructed or the demand has begun to be met (step 370), the scheduler 132 engages the utilized resources 120 by communicating with the resources and requesting engagement, then ends the process at an end step 380.

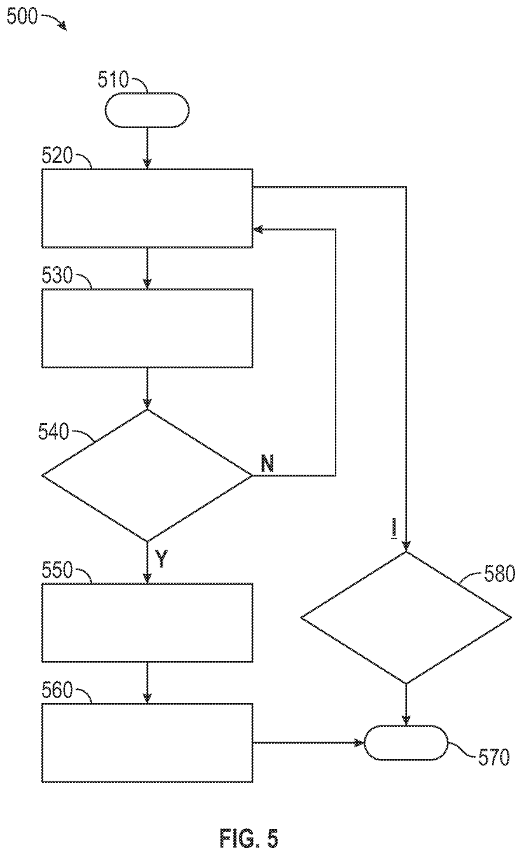

With continued reference to FIGS. 1-4, FIG. 5 illustrates a process 500 for monitoring a resource 120 that has been engaged to meet an energy demand event 410 throughout the energy demand event 410. The process starts at a start block 510, and a monitoring system within the resource 120 is engaged to monitor any anomalies within the energy discharge of the resource 120 in a Monitor KPI Anomalies step 520. The anomalies are deviations from expected operations of one or more key performance indicator metrics 210, 220, 230 of the resource 120. When an anomaly occurs, the anomaly is assigned a weight, which is then added to a total anomaly value of the engagement in a Calculate Anomaly score step 530. In one example, all types of anomalies are assigned a static value (e.g., one) and the total anomaly score operates as counter counting the number of anomaly's that have occurred. In other examples, the anomalies can have different values depending on the type of anomaly, and the total anomaly score is the sum of all values that have occurred.

Once the total anomaly score has been determined at step 530, the total anomaly score is compared to a threshold score at a comparison check 540. When the score does not exceed the threshold, the process 500 continues the engagement, and the process 500 returns to step 520.

Alternatively, when the total anomaly score exceeds the threshold, the process 500 determines that the resource 120 is no longer sufficient to meet the energy demand event 410 and the resource 120 is disengaged at a Disengage step 550. The disengagement is reported back to the remote computer system 130 at a Report the Anomaly to the Cloud step 560, and the scheduler 132 is able to reassign a new resource 120 to meet the ongoing energy demand event 410. Subsequent to the reporting, the monitoring process 500 ends at end step 570.

When the energy demand event 410 ends naturally, either due to the energy demand being met (e.g., a source 420 being fully charged), the conditions causing the energy demand ceasing (e.g., a downed power line being fixed), or for any other external reason, an interrupt 580 interrupts the monitoring process and provides a normal resource 120 disengagement.

By using the above described systems and processes, the remote computer system 130 is able to continuously control and meet energy requirements during a demand event 410 and balance throughput and latency of the various resources 120 able to be used to meet the demand.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A process for responding to an energy demand event comprising:
identifying an energy demand event;
ranking a plurality of distributed energy resources according to a dynamic state of health of each distributed energy resource;
assigning at least one distributed energy resource to meet the energy demand event; and
monitoring an anomaly count of at least one of the at least one distributed energy resources throughout the energy demand event.

2. The process of claim 1, wherein ranking the plurality of distributed energy resources includes receiving a set of key performance indicator metrics from each resource, determining a key performance indicator value corresponding to each key performance indicator metric using a key performance indicator determinator, and determining a dynamic state of health indicator value corresponding to the key performance indicator value for each key performance indicator metric using a dynamic state of health determinator.

3. The process of claim 2, wherein at least one of the key performance indicator determinator and the dynamic state of health determinator is a software module local to the corresponding distributed energy resource.

4. The process of claim 2, wherein at least one of the key performance indicator determinator and the dynamic state of health determinator is a software module local to the corresponding distributed energy resource is remote from the corresponding distributed energy resource.

5. The process of claim 2, wherein at least one of the key performance indicator determinator and the dynamic state of health determinator is a rules based determinator.

6. The process of claim 2, wherein at least one of the key performance indicator determinator and the dynamic state of health determinator is at least partially machine learning based, and wherein a machine learning of the at least one of the key performance indicator determinator and the dynamic state of health determinator is retrained using outputs of the at least one of the key performance indicator determinator and the dynamic state of health determinator.

7. The process of claim 6, wherein each of the key performance indicator determinator and the dynamic state of health determinator are at least partially machine learning based.

8. The process of claim 2, further comprising determining a total dynamic state of health value based on an average of each key performance indicator dynamic state of health value.

9. The process of claim 8, wherein the average is a weighted average.

10. The process of claim 2, wherein at least one of the dynamic state of health indicator values is based at least in part on a historical average of the key performance indicator values of the corresponding key performance indicator metric.

11. The process of claim 1, wherein assigning the at least one distributed energy resource to meet the energy demand event comprises applying a throughput versus latency optimization algorithm, wherein a throughput of a resource is a magnitude of energy provided by the resource and a latency of the resource is a time until completed delivery of the energy provided by the resource.

12. The process of claim 11, wherein applying the throughput versus latency optimization comprises evaluating a throughput and latency of each resource in the plurality of distributed energy resources and assigning the at least one distributed energy resource to meet the energy demand event comprises assigning an optimal subset of the plurality of distributed energy resources to meet the energy demand event.

13. The process of claim 12, wherein assigning the optimal subset of the plurality of distributed energy resources comprises instructing at least one mobile distributed energy resource to move from a first location to a second location.

14. The process of claim 12, wherein monitoring an anomaly count of at least one of the at least one distributed energy resources throughout the energy demand event comprises monitoring each key performance indicator, incrementing an anomaly counter in response to detecting an anomaly, comparing the anomaly counter to a threshold and disengaging the distributed energy resource from the energy demand event in response to the anomaly counter exceeding the threshold.

15. The process of claim 14, further comprising responding to an end of the energy demand event by interrupting the monitoring the anomaly count of at least one of the at least one distributed energy resources and disengaging the distributed energy resource from the energy demand event.

16. The process of claim 1, wherein the plurality of distributed energy resources includes a set of mobile distributed energy resources and a set of immobile distributed energy resources.

17. The process of claim 16, wherein the set of mobile distributed energy resources includes at least one vehicle, and wherein the at least one vehicle includes a rechargeable energy storage system and a controller.

18. The process of claim 17, wherein the process includes determining a key performance indicator value corresponding to each key performance indicator metric using a key performance indicator determinator and determining a dynamic state of health indicator value corresponding to the key performance indicator value for each key performance indicator metric using a dynamic state of health determinator, and wherein at least one of the key performance indicator determinator and the dynamic state of health determinator is a software module of the controller.

19. The process of claim 1, further comprising identifying at least one additional energy demand event, reiterating the ranking the plurality of distributed energy resources according to a dynamic state of health of each distributed energy resource, and assigning at least one distributed energy resource to meet the at least one additional energy demand event, and wherein assigning at least one distributed energy resource to meet the at least one additional energy demand event comprises identifying a distributed energy resource currently assigned to an energy demand event and reassigning the identified distributed energy resource to one of the at least one additional energy demand events.

20. A process for responding to an energy demand event comprising:
identifying an energy demand event;
ranking a plurality of distributed energy resources according to a dynamic state of health of each distributed energy resource, wherein ranking the plurality of distributed energy resources includes receiving a set of key performance indicator metrics from each resource, determining a key performance indicator value corresponding to each key performance indicator metric using a key performance indicator determinator, and determining a dynamic state of health indicator value corresponding to the key performance indicator value for each key performance indicator metric using a dynamic state of health determinator;
assigning at least one distributed energy resource to meet the energy demand event; and
monitoring an anomaly count of at least one of the at least one distributed energy resources throughout the energy demand event.
